(19) United States
(12) Patent Application Publication
(10) Pub. No.: US 2024/0282106 A1
(43) Pub. Date: Aug. 22, 2024

(54) Security Operations via Augmented Reality Devices

(71) Applicant: Micron Technology, Inc., Boise, ID (US)

(72) Inventors: Saideep Tiku, Folsom, CA (US); Poorna Kale, Folsom, CA (US)

(21) Appl. No.: 18/415,018

(22) Filed: Jan. 17, 2024

Related U.S. Application Data
(60) Provisional application No. 63/485,471, filed on Feb. 16, 2023.

(51) Int. Cl. G06V 20/20; G06F 3/147; G06V 10/74; G06V 10/82; G06V 20/52; G06V 40/16; G06V 40/20

(52) U.S. Cl. CPC G06V 20/20; G06F 3/147; G06V 10/74; G06V 10/82; G06V 20/53; G06V 40/168; G06V 40/173; G06V 40/174; G06V 40/20

(57) ABSTRACT

An augment reality security system to identify outliers in behaviors. For example, cameras can be each configured to capture images, compress the images, and provide compressed images having embeddings representative of features determined by an artificial neural network. A server computer can receive, from the plurality of cameras, compressed images to generate analytics of embeddings of features in the compressed images, identify from the analytics an anomaly associated with a first face, and determine metrics representative of features of the first face in an image. A pair of augmented reality glasses can have a computing unit to detect a second face in a view through the glasses, communicate with the server computer to determine a match of the second face with the first face based on the metrics, and generate an augmented reality display in the view to identify the first face.

### RELATED APPLICATIONS

The present application claims priority to Prov. U.S. Pat. App. Ser. No. 63/485,471 filed Feb. 16, 2023, the entire disclosures of which application are hereby incorporated herein by reference.

### TECHNICAL FIELD

At least some embodiments disclosed herein relate to security operations in general and more particularly, but not limited to, security operations implemented via augmented reality devices, such as smart glasses.

### BACKGROUND

Augmented reality glasses (e.g., smart glasses) can present a virtual object in the field of view of a user in a way as if the virtual object were part of the real world as seen by the user. Such an augmented reality device can include a microprocessor and a memory sub-system powered by a battery pack.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates a security system implemented via augmented reality glasses configured according to one embodiment.

FIG. 2 shows a computing unit configured to process an image using an integrated circuit device and an artificial neural network according to one embodiment.

FIG. 3 shows another computing unit according to one embodiment.

FIG. 4 shows the computation of a column of weight bits multiplied by a column of input bits to provide an accumulation result according to one embodiment.

FIG. 5 shows the computation of a column of multi-bit weights multiplied by a column of input bits to provide an accumulation result according to one embodiment.

FIG. 6 shows the computation of a column of multi-bit weights multiplied by a column of multi-bit inputs to provide an accumulation result according to one embodiment.

FIG. 7 shows an image processing logic circuit using an inference logic circuit in image compression according to one embodiment.

FIG. 8 and FIG. 9 illustrate examples of an image processing logic circuit using an inference logic circuit in image compression according to one embodiment.

FIG. 10 shows a computing unit having a passive neural network and a digital multiplication and accumulation accelerator configured according to one embodiment.

FIG. 11 illustrates the processing of an image using a passive neural network configured according to one embodiment.

FIG. 12 shows a method of augmented reality according to one embodiment.

### DETAILED DESCRIPTION

At least some embodiments disclosed herein provide an augmented reality vigilance system that can be used to detect and monitor abnormal conditions and behaviors, outliers, suspects, etc.

For example, a set of smart cameras can be configured to capture video images of a location, facility, or venue having a crowd of people. The cameras are configured to compress the captured video images via deep learning.

A server computer system is connected to the cameras to generate analytics of compressed embeddings provided by the cameras. The analytics can capture varying attributes of people over time at the location, facility, or venue. The server computer system can identify any recent changes in behavior to detect anomalies and outliers that are indicative of conditions of concerns.

For example, the server computer system can be configured to analyze, using an artificial neural network, walking patterns of persons to detect signs of intoxication, sickness, injury, etc. For example, the server computer system can perform expression analyses, using an artificial neural network, to detect conditions of concerns. For example, unexpected expressions of pain, anger, etc. of a person in a crowd of people that do not show such expressions can be detected as an outlier of concern. For example, the server computer system can analyze, using an artificial neural network, to detect a possible incident of crime and the face of a suspect.

An authorized user (e.g., a guard, officer, or representative) can wear a pair of augmented reality glasses facing the crowd of people. In response to detection of a face in the view, the augmented reality glasses can perform computations and communications with the server computer system to recognize the face for an identification of a person having the face.

For example, the server computer system can determine whether the person with the detected face has information to be presented to the authorized user, such as abnormal conditions and behaviors detected and captured by the smart cameras. For example, if the face recognized in the augmented reality glasses is associated with signs of intoxication, sickness, injury, or unexpected expressions of concern, the server computer system can present such information to the authorized user via the augmented reality glasses.

For example, the information can be projected onto the field of view of the glasses to identify the person of concern in the crowd and the causes of concerns. For example, the augmented reality glasses can present augmented reality display to highlight the person of interest/concern for the attention of the authorized person. For example, a symbol indicative of the classification of the causes of concerns can be presented near the face of the person to augment the scene as seen through the glasses.

Optionally, a portion of the information can be presented via audio signals transmitted via headphones or speakers configured on, or connected to, the glasses.

Thus, the augmented reality glasses can equip the authorized user with the augmented reality identification of the person of concern in the field of view and relevant information. With the help of the augmented reality presentation, the authorized user can monitor the situation and optionally take actions to provide help, defuse a crisis, disrupt a crime, arrest a suspect, etc.

Optionally, the augmented reality glasses can automatically record a video of the authorized user viewing the recognized face through the glasses and interacting with the person. The recorded video can be used in a subsequent review process for evaluation of the scenario and for training of authorized users in the handling of similar scenarios.

Privacy protection can be implemented across the system. Information can be provided on demand and/or on a need to know basis. For example, the presentation of the live metrics/analytics about detected faces through the augmented reality glasses can be performed after the authentication of a user of the augmented reality glasses. Authorization to present augmented reality information can be limited to a time period during which the user is scheduled and tasked to perform a security duty. When the user is off duty, the information presentation through the augmented reality glasses can be blocked. Further, the information presentation can be limited to an uninterrupted time period during which the user is wearing the augmented reality glasses following an authentication of the user. In response to a detection of the augmented reality glasses being lifted off the user, the session of authorized information presentation can be terminated; and further authentication can be required to activate the function of presenting information through augmented reality.

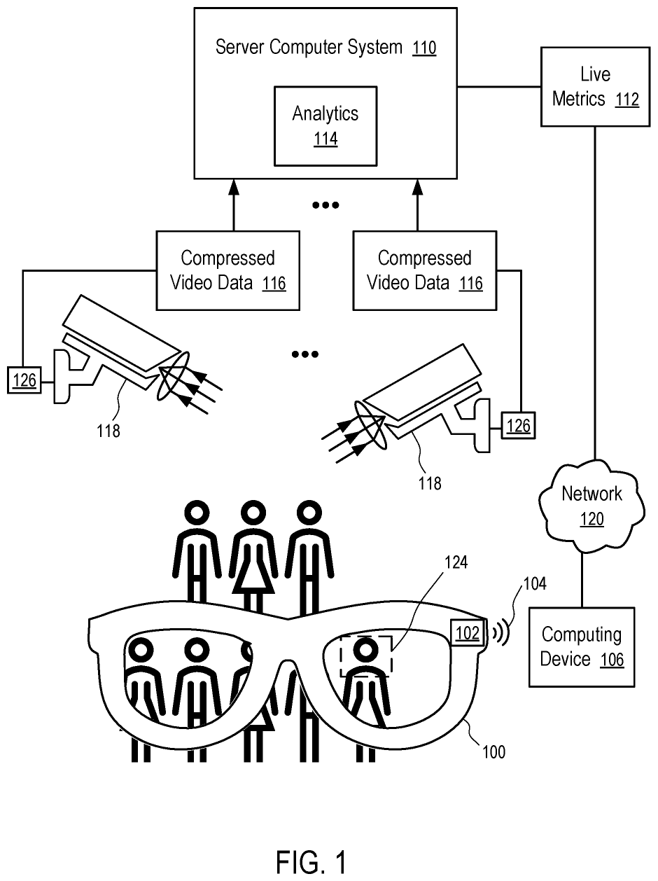

FIG. 1 illustrates a security system implemented via augmented reality glasses configured according to one embodiment.

In FIG. 1, an augmented reality device, such as a pair of smart glasses 100, can be configured to use an artificial neural network to analyze an image of a scene, detect and recognize faces of persons of interest in the image, and provide information about the recognized faces to the user of the device via augmenting the reality of the scene.

For example, the smart glasses 100 can include a computing unit 102 configured to analyze the image of the scene in the field of view of the glasses 100 using the artificial neural network. When the computing unit 102 detects a face 124 in the field of view of glasses, the glasses 100 can communicate, through a wireless connection 104, with a server computer system 110 over a network 120 to obtain information about the face 124, and present the information via the glasses 100 in a way as if the information were part of the scene as seen through the glasses 100.

Optionally, the glasses 100 can communicate with the server computer system 110 via a nearby computing device 106, such as a mobile phone, a personal computer, a tablet computer, etc. The computing device 106 can be configured to perform part of the computations in recognizing the face 124 and generate the augmented reality display of the information related to the face 124.

For example, the wireless connection 104 can be a wireless personal area network connection (e.g., a Bluetooth connection) or a wireless local area network connection (e.g., a Wi-Fi connection) to the computing device 106. Alternatively, the wireless connection 104 can be a wireless wide area connection (e.g., a cellular communications connection).

The server computer system 110 can be connected to a set of cameras 118 configured to monitor an area, location, facility, or venue. Such a camera 118 can have a computing unit 126 configured to generate compressed video data 116 captured by the camera 118 for transmission to the server computer system 110. Optionally, image sensors (e.g., 143) of smart glasses (e.g., 100) can be used as, or in additional to, the deployment of such cameras (e.g., 118).

For example, the computing unit 126 can be configured to perform video/image compression via deep learning. Image features are extracted via an artificial neural network to facilitate object and pattern recognition. The compressed video data 116 includes the compressed embedding of features to allow the server computer 110 to perform object and pattern recognition and generate analytics 114.

For example, the analytics 114 can include metrics 112 of image features of faces and identification of conditions or behaviors of concern of the corresponding persons, such as signs of intoxication, sickness, injury, or unexpected expressions, etc.

For example, in response to the detection of an anomaly in behavior or condition, the server computer system 110 can store the metrics 112 of image features of an associated face, a classification of the anomaly, and optionally an image or video clip of the anomaly.

Optionally, the computing unit 126 include an edge server configured to perform object and pattern recognition to generate analytics 114, such as a classification of the anomaly, the metrics 112 of image features of a face associated with the anomaly, and an image or video clip of the anomaly. The edge server can communicate the analytics 114 to the server computer system 110 and thus reduce the communication bandwidth requirement for the server computer system 110.

The server computer system 110 can provide the metrics 112 to the smart glasses 100 for detection and recognition. When a face 124 appearing in the field of view of the glasses 100 is recognized for a match with the metrics 112, the computing unit 102 of the glasses 100 can communicate with the server computer system 110 to obtain information about the recognized face, such as a classification of the anomaly recorded in the association with the metrics 112 of the face 124.

Alternatively, when the computing unit 102 of the smart glasses 100 detects a face 124, the computing unit 102 can communicate the metrics of the face 124 to the server computer system 110. When the server computer system 110 determines a match of the received metrics 112 with a corresponding metrics 112 recorded for an anomaly, the server computer system 110 can provide information about the recorded anomaly to the glasses 100 for augmented reality presentation.

For example, when the face 124 in the field of view of the glasses 100 is determined to have anomaly information, the face 124 can be highlighted in the view via augmented reality display of a box or trace round the person as shown in the field of view of the glasses 100. Optionally, a symbol or indication of the classification of the anomaly can be presented next to the face 124. Optionally, upon activation, a representative image or video clip of the anomaly as captured by a smart camera 118 can be presented via the glasses 100. Optionally, the identity of the person having the face is determined and relevant records about the person can be looked up by the server computer system 110 for presentation to the user of the glasses 100. For example, text information can be converted to audio signals transmitted via headphones or speakers configured on, or connected to, the glasses 100 upon request from the user of the glasses 100.

Optionally, after a review of the relevant information and/or the situation as seen through the glasses 100, the user of the glasses 100 can dismiss the anomaly designation of the image/video recorded in the analytics. Upon receiving such a dismissal, the glasses 100 can transmit the user input to the server computer system 110 to suppress the matching for the face 124 having the metrics 112 such that the system can better focus other instances of anomalies and their associated faces.

FIG. 1 illustrates the deployment of a pair of augmented glasses 100 as an example. In general, multiple pairs of augmented glasses 100 can be worn by multiple authorized users to handle anomalies in a crowd of people.

The techniques are discussed above in connection with the recognition of faces. The techniques can also be used in the recognition of other traits or identifications of objects, such as vehicle identification, license plate numbers, etc. For example, the cameras can be used to monitor vehicles to detect erratic driving, speeding, etc.; and the metrics of the vehicle involving the anomaly can be recorded for recognition in the field of view of the augmented glasses 100 for the attention of the authorized user of the glasses 100.

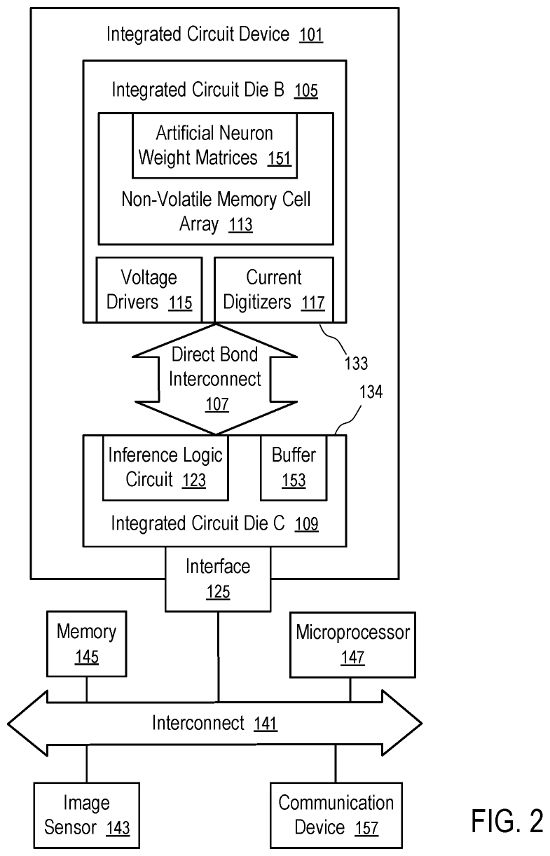

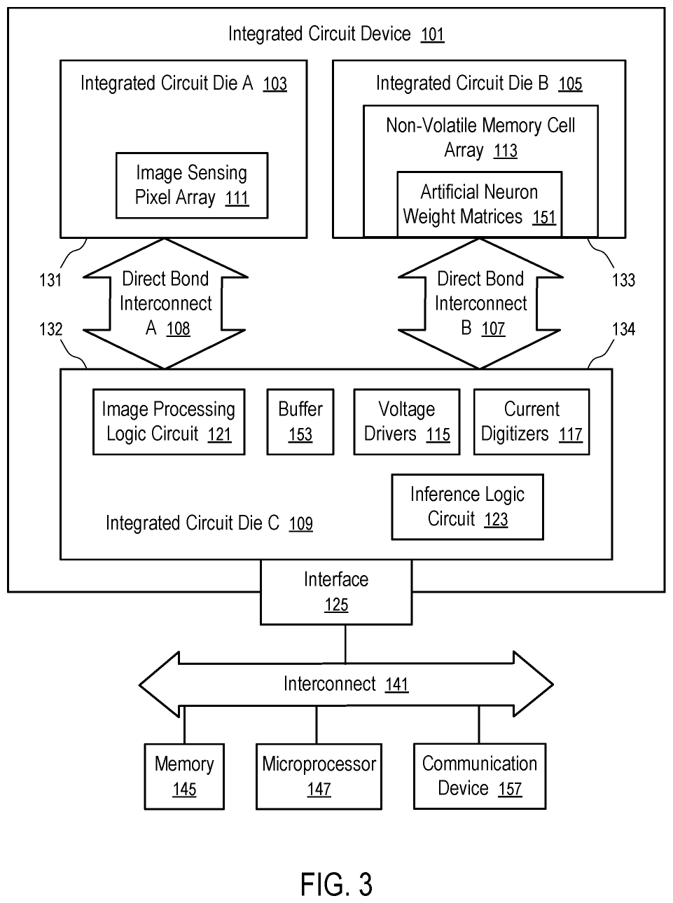

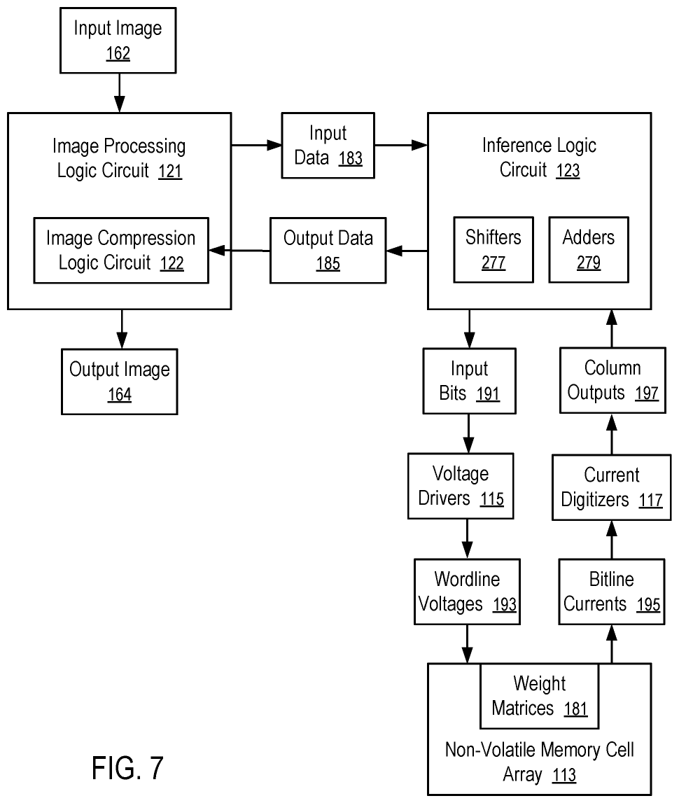

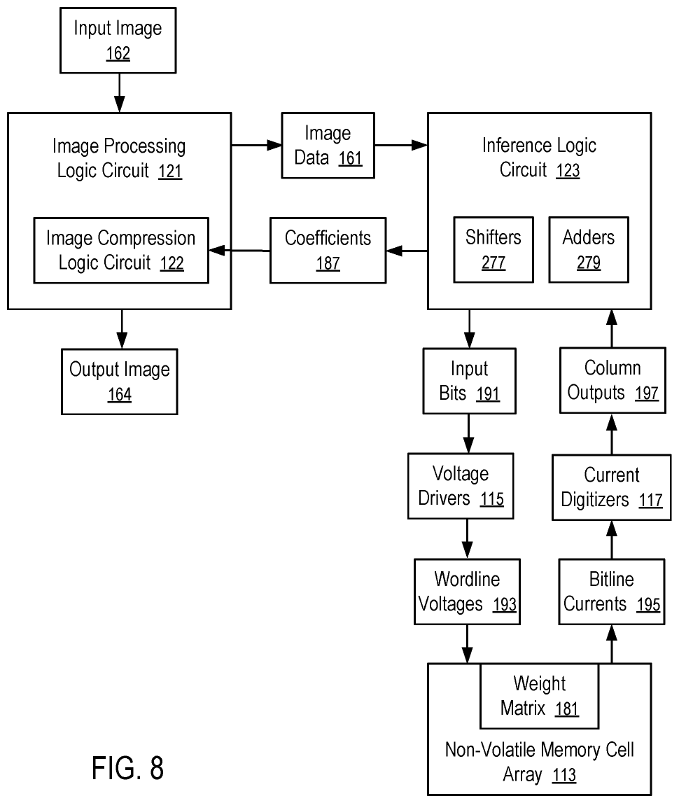

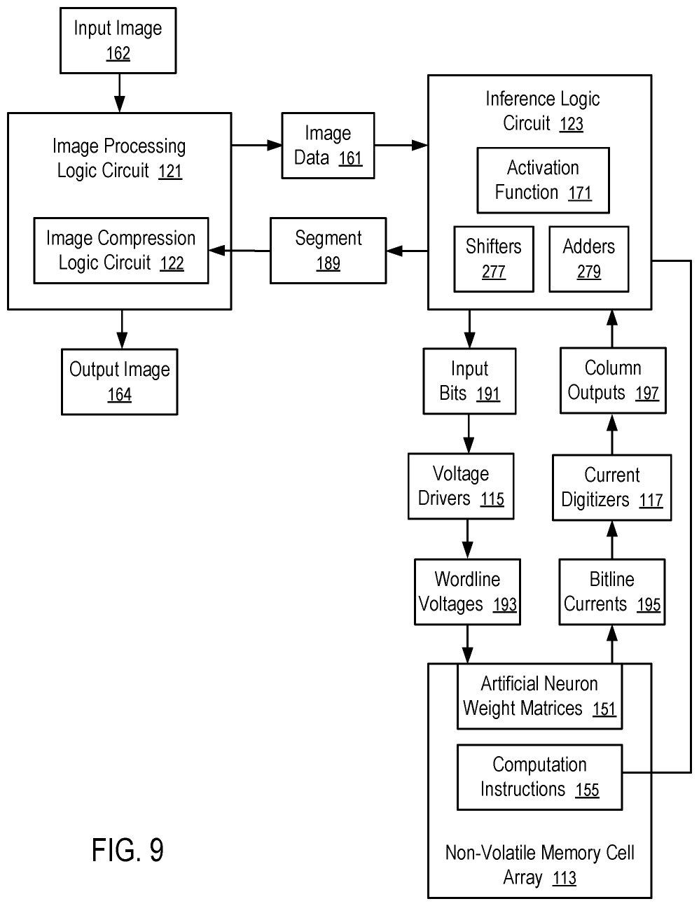

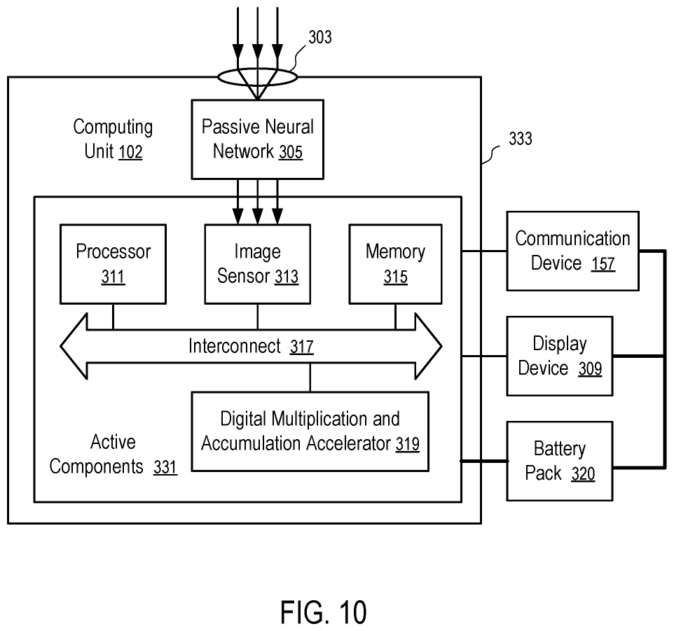

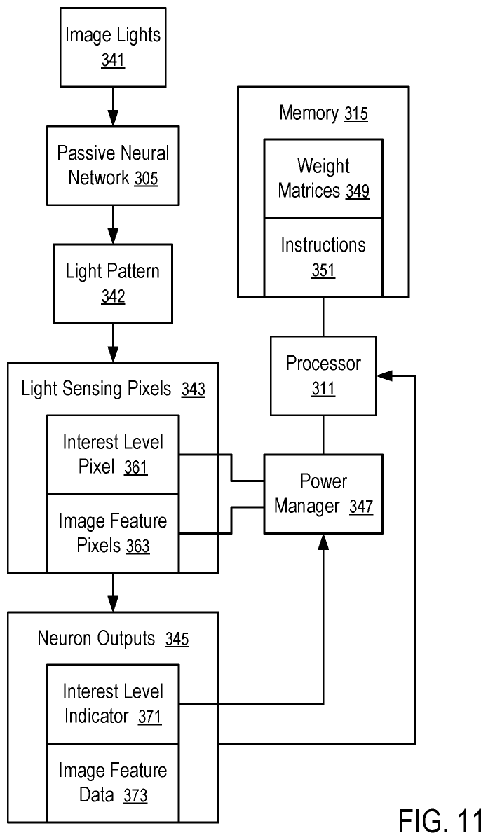

Optionally, the computing units 126 of the cameras 118 can be configured as in FIG. 2 or FIG. 3 to perform image compression using the techniques of FIG. 7, FIG. 8, and FIG. 9. The computing unit 102 of the augmented reality glasses can be configured as in FIG. 10 to manage power usage using the techniques of FIG. 11. Other implementations of the computing units 102 and/or 126 (e.g., implemented using a programmable microprocessor and instructions programmed to be executed by the microprocessor) can used. The system of FIG. 1 is not limited to the implementations of FIG. 2, FIG. 3, and FIG. 10.

FIG. 2 shows a computing unit configured to process an image using an integrated circuit device and an artificial neural network according to one embodiment.

In FIG. 2, an integrated circuit device 101 has a memory chip (e.g., integrated circuit die 105) and a logic chip (e.g., integrated circuit die 109). Optionally, the integrated circuit device 101 of FIG. 2 can have an image chip (e.g., integrated circuit die 103) as in FIG. 3. Alternatively, the integrated circuit device 101 of FIG. 2 can be manufactured to have no image chip.

In FIG. 2, the interface 125 of the integrated circuit device 101 can receive commands to write an image into the integrated circuit device 101 as a memory device, or a storage device, or both.

For example, the image sensor 143 can write an image through the interconnect 141 (e.g., one or more computer buses) into the interface 125. Alternatively, a microprocessor 147 can function as a host system to retrieve an image from the image sensor 143, optionally buffer the image in the memory 145, and write the image to the interface 125. The interface 125 can place the image data in the buffer 153 as an input to the inference logic circuit 123.

In some implementations, when the integrated circuit device 101 has an image sensing pixel array 111 (e.g., as in FIG. 3), the image chip or the image processing logic circuit 121 can send image data to the buffer 153 directly, or through the interface 125.

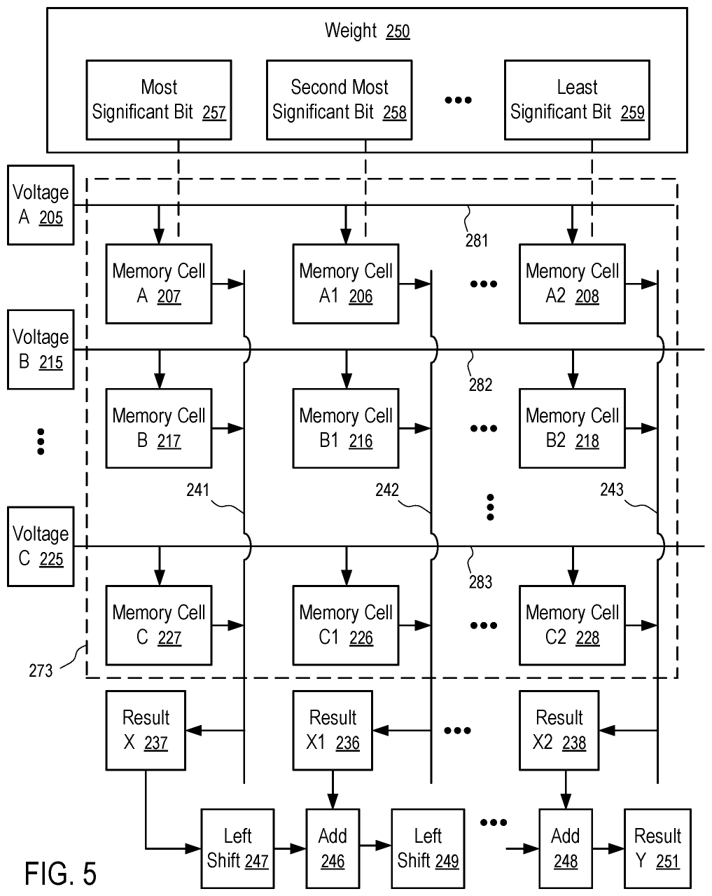

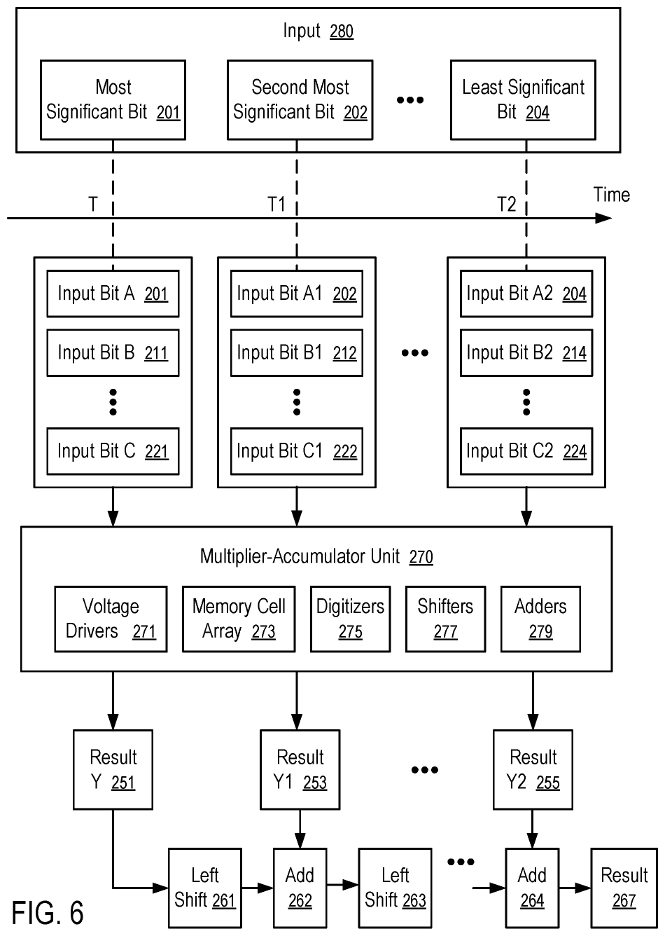

In response to the image data in the buffer 153, the inference logic circuit 123 can generate a column of inputs. The memory cell array 113 in the memory chip (e.g., integrated circuit die 105) can store an artificial neuron weight matrix 151 configured to weigh on the inputs to an artificial neural network. The inference logic circuit 123 can instruct the voltage drivers 115 to apply a column of significant bits of the inputs a time to an array of memory cells storing the artificial neuron weight matrix 151 to obtain a column of results (e.g., 251) using the technique of FIG. 5 and FIG. 6. The inference logic circuit 123 can transform the column of results (e.g., according to activation functions of artificial neurons) to generate a next column of inputs to be further weighted on using a further artificial neuron weight matrix 151. The process can continue until a last artificial neuron weight matrix 151 is applied to produce the output of the artificial neural network.

The inference logic circuit 123 can be configured to place the output of the artificial neural network into the buffer 153 for retrieval as a response to, or replacement of, the image written to the interface 125. Optionally, the inference logic circuit 123 can be configured to write the output of the artificial neural network into the memory cell array 113 in the memory chip. In some implementations, an external device (e.g., the image sensor, the microprocessor 147) writes an image into the interface 125; and in response to the integrated circuit device 101 generates the output of the artificial neural network in response to the image and write the output as a replacement of the image into the memory chip.

The memory cells in the memory cell array 113 can be non-volatile. Thus, once the weight matrices 151 are written into the memory cell array 113, the integrated circuit device 101 has the computation capability of the artificial neural network without further configuration or assistance from an external device (e.g., a host system). The computation capability can be used immediately upon supplying power to the integrated circuit device 101 without the need to boot up and configure the integrated circuit device 101 by a host system (e.g., microprocessor 147 running an operating system). The power to the integrated circuit device 101 (or a portion of it) can be turned off when the integrated circuit device 101 is not used in computing an output of an artificial neural network, and not used in reading or write data to the memory chip. Thus, the energy consumption of the computing system can be reduced.

In some implementations, the inference logic circuit 123 is programmable to perform operations of forming columns of inputs, applying the weights stored in the memory chip, and transforming columns of data (e.g., according to activation functions of artificial neurons). The instructions can also be stored in the non-volatile memory cell array 113 in the memory chip.

In some implementations, the inference logic circuit 123 includes an array of identical logic circuits configured to perform the computation of some types of activation functions, such as step activation function, rectified linear unit (ReLU) activation function, heaviside activation function, logistic activation function, gaussian activation function, multiquadratics activation function, inverse multiquadratics activation function, polyharmonic splines activation function, folding activation functions, ridge activation functions, radial activation functions, etc.

In some implementations, the multiplication and accumulation operations in an activation function are performed using multiplier-accumulator units 270 implemented using memory cells in the array 113.

Some activation functions can be implemented via multiplication and accumulation operations with fixed weights.

The integrated circuit die 105 having the memory cell array 113 has a bottom surface 133; and the integrated circuit die 109 having the inference logic circuit 123 has a portion of a top surface 134. The two surfaces 133 and 134 can be connected via hybrid bonding to provide a portion of a direct bond interconnect 107 between the metal portions on the surfaces 133 and 134.

Direct bonding is a type of chemical bonding between two surfaces of material meeting various requirements. Direct bonding of wafers typically includes pre-processing wafers, pre-bonding the wafers at room temperature, and annealing at elevated temperatures. For example, direct bonding can be used to join two wafers of a same material (e.g., silicon); anodic bonding can be used to join two wafers of different materials (e.g., silicon and borosilicate glass); eutectic bonding can be used to form a bonding layer of eutectic alloy based on silicon combining with metal to form a eutectic alloy.

Hybrid bonding can be used to join two surfaces having metal and dielectric material to form a dielectric bond with an embedded metal interconnect from the two surfaces. The hybrid bonding can be based on adhesives, direct bonding of a same dielectric material, anodic bonding of different dielectric materials, eutectic bonding, thermocompression bonding of materials, or other techniques, or any combination thereof.

FIG. 3 shows another computing unit according to one embodiment.

The integrated circuit device 101 in FIG. 3 has an integrated circuit die 109 with an inference logic circuit 123 and a non-volatile memory cell array 113 as in FIG. 2.

In FIG. 3, the voltage drivers 115 and the current digitizers 117 are configured in the logic chip (e.g., integrated circuit die 109 having the inference logic circuit 123). Alternatively, at least a portion of the voltage drivers 115 and the current digitizers 117 can be implemented in the memory chip (e.g., integrated circuit die 105 having the memory cell array 113).

In FIG. 3, the integrated circuit device 101 includes an image chip (e.g., integrated circuit die 103 having image sensing pixel array 111).

An image processing logic circuit 121 in the logic chip can pre-process an image from the image sensing pixel array 111 as an input to the inference logic circuit 123. After the image processing logic circuit 121 stores the input into the buffer 153, the inference logic circuit 123 can perform the computation of an artificial neural network in a way similar to the integrated circuit device 101 of FIG. 2.

For example, the inference logic circuit 123 can store the output of the artificial neural network into the memory chip in response to the input in the buffer 153.

Optionally, the image processing logic circuit 121 can also store one or more versions of the image captured by the image sensing pixel array 111 in the memory chip as a solid-state drive.

An application running in the microprocessor 147 can send a command to the interface 125 to read at a memory address in the memory chip. In response, the image sensing pixel array 111 can capture an image; the image processing logic circuit 121 can process the image to generate an input in the buffer; and the inference logic circuit 123 can generate an output of the artificial neural network responding to the input. The integrated circuit device 101 can provide the output as the content retrieved at the memory address; and the application running in the microprocessor 147 can determine, based on the output, whether to read further memory addresses to retrieve the image or the input generated by the image processing logic circuit 121. For example, the artificial neural network can be trained to generate a classification of whether the image captures an object of interest and if so, a bounding box of a portion of the image containing the image of the object and a classification of the object. Based on the output of the artificial neural network, the application running in the microprocessor 147 can decide whether to retrieve the image, or the image of the object in the bounding box, or both.

In some implementations, the original image, or the input generated by the image processing logic circuit 121, or both can be placed in the buffer 153 for retrieval by the microprocessor 147. If the microprocessor 147 decides not to retrieve the image data in view of the output of the artificial neural network, the image data in the buffer 153 can be discarded when the microprocessor 147 sends a command to the interface 125 to read a next image.

Optionally, the buffer 153 is configured with sufficient capacity to store data for up to a predetermined number of images. When the buffer 153 is full, the oldest image data in the buffer is erased.

When the integrated circuit device 101 is not in an active operation (e.g., capturing an image, operating the interface 125, or performing the artificial neural network computations), the integrated circuit device 101 can automatically enter a low power mode to avoid or reduce power consumption. A command to the interface 125 can wake up the integrated circuit device 101 to process the command.

The integrated circuit die 103 having the image sensing pixel array 111 has a bottom surface 131; and the integrated circuit die 109 having the inference logic circuit 123 has another portion of its top surface 132. The two surfaces 131 and 132 can be connected via hybrid bonding to provide a portion of a direct bond interconnect 108 between the metal portions on the surfaces 133 and 134. Alternatively, microbumps can be used to connect the image sensing pixel array 111 to the image processing logic circuit 121.

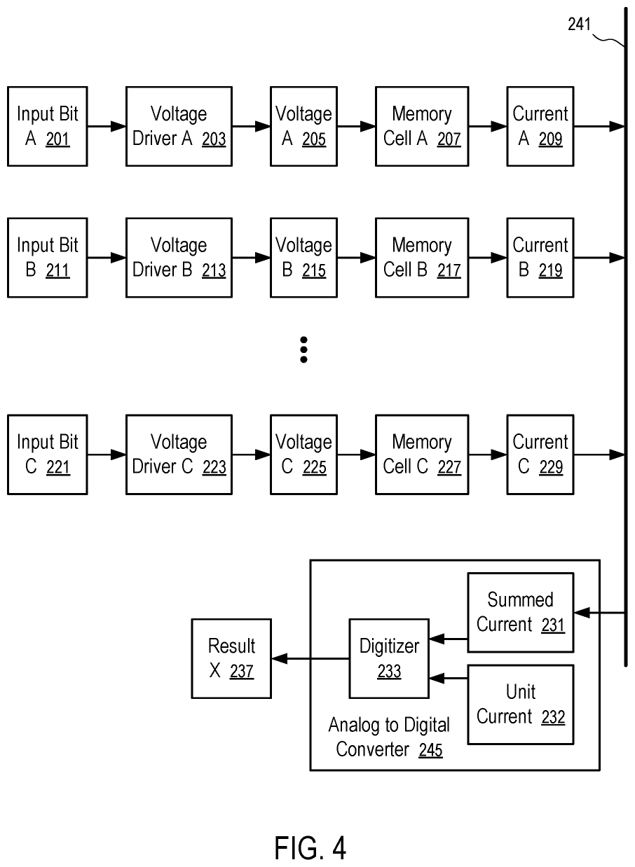

FIG. 4 shows the computation of a column of weight bits multiplied by a column of input bits to provide an accumulation result according to one embodiment.

In FIG. 4, a column of memory cells 207, 217, . . . , 227 (e.g., in the memory cell array 113 of an integrated circuit device 101) can be programmed to have threshold voltages at levels representative of weights stored one bit per memory cell.

Voltage drivers 203, 213, . . . , 223 (e.g., in the voltage drivers 115 of an integrated circuit device 101) are configured to apply voltages 205, 215, . . . , 225 to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . , 227 are connected to a common line 241 for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 4, the voltages 205, 215, . . . , 225 applied to the memory cells 207, 217, . . . , 227 are representative of digitized input bits 201, 211, . . . , 221; the memory cells 207, 217, . . . , 227 are programmed to store digitized weight bits; and the currents 209, 219, . . . , 229 are representative of digitized results. Thus, the memory cells 207, 217, . . . , 227 do not function as memristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 4 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

In general, a weight involving a multiplication and accumulation operation can be more than one bit. Multiple columns of memory cells can be used to store the different significant bits of weights, as illustrated in FIG. 5 to perform multiplication and accumulation operations.

The circuit illustrated in FIG. 4 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 5.

The circuit illustrated in FIG. 4 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 4 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 5 shows the computation of a column of multi-bit weights multiplied by a column of input bits to provide an accumulation result according to one embodiment.

In FIG. 5, a weight 250 in a binary form has a most significant bit 257, a second most significant bit 258, . . . , a least significant bit 259. The significant bits 257, 258, . . . , 259 can be stored in memory cells 207, 206, . . . , 208 in a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 4).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 4); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 4).

The most significant bits (e.g., 257) of the weights (e.g., 250) stored in the respective rows of memory cells in the array 273 are multiplied by the input bits 201, 211, . . . , 221 represented by the voltages 205, 215, . . . , 225 and then summed as the current 231 in a line 241 and digitized using a digitizer 233, as in FIG. 4, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 6.

The circuit illustrated in FIG. 5 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . , 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . , 248 provides the weight 250 in a binary form.

In general, the circuit illustrated in FIG. 5 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 6 shows the computation of a column of multi-bit weights multiplied by a column of multi-bit inputs to provide an accumulation result according to one embodiment.

In FIG. 6, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 5. The multiplier-accumulator unit 270 has voltage drivers 271 connected to apply voltages 205, 215, . . . , 225 representative of the input bits 201, 211, . . . , 221. The multiplier-accumulator unit 270 has a memory cell array 273 storing bits of weights as in FIG. 5. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 5.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280). The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

FIG. 7 shows an image processing logic circuit using an inference logic circuit in image compression according to one embodiment.

In FIG. 7, an image processing logic circuit 121 in a logic chip (e.g., integrated circuit die 109) in an integrated circuit device 101 is configured to compress an input image 162 to generate an output image 164. The image compression can include lossy compression, lossless compression, image trimming, etc.

The image compression computation can include, or formulated to include, multiplication and accumulation operations based on weight matrices 181 stored in a memory chip (e.g., integrated circuit die 105) in the integrated circuit devices 101. Preferably, the weight matrices 181 do not change for typical image compression such that the weight matrices 181 can be written into the non-volatile memory cell array 113 without repeatedly erasing and programming so that the useful life of the non-volatile memory cell array 113 can be extended. Some types of non-volatile memory cells (e.g., cross point memory) can have a high budget for erasing and programming. When the memory cells in the array 113 can tolerate a high number of erasing and programming cycles, the image compression computation can also be formulated to use weight matrices 181 that change during the computations of image compression.

The image processing logic circuit 121 can include an image compression logic circuit 122 configured to generate input data 183 for the inference logic circuit 123 to apply operations of multiplication and accumulation on weight matrices 181 to generate output data 185. The input data 183 can include, for example, pixel values of the input image 162, an identification/address of a weight matrix 181 stored in the memory cell array 113, or other data derived from the pixel values, or any combination thereof. After the operations of the multiplication and accumulation, the image processing logic circuit 121 can use the output data 185 received from the inference logic circuit 123 in compressing the input image 162 into the output image 164.

The input data 183 identifies a matrix 181 stored in the memory cell array 113 and a column of inputs (e.g., 280). In response, the inference logic circuit 123 uses a column of input bits 191 to control voltage drivers 115 to apply wordline voltages 193 onto rows of memory cells storing the weights of a matrix 181 identified by the input data 183. The voltage drivers 115 apply voltages of predetermined magnitudes on wordlines to represent the input bits 191. The memory cells in the memory cell array 113 are configured to output currents that are negligible or multiples of a predetermined amount of current 232. Thus, the combination of the voltage drivers 115 and the memory cells storing the weight matrices 181 functions as digital to analog converters configured to convert the results of bits of weights (e.g., 250) multiplied by the bits of inputs (e.g., 280) into output currents (e.g., 209, 219, . . . , 229). Bitlines (e.g., lines 241, 242, . . . , 243) in the memory cell array 113 sum the currents in an analog form. The summed currents (e.g., 231) in the bitlines (e.g., line 241) are digitized as column outputs 197 by the current digitizers 117 for further processing in a digital form (e.g., using shifters 277 and adders 279 in the inference logic circuit 123) to obtain the output data 185.

As illustrated in FIG. 4 and FIG. 5, the wordline voltages 193 (e.g., 205, 215, . . . , 225) are representative of the applied input bits 191 (e.g., 201, 211, . . . , 221) and cause the memory cells in the array 113 to generate output currents (e.g., 209, 21, . . . , 229). The memory cell array 113 connects output currents from each column of memory cells to a respective line (e.g., 241, 242, . . . , or 243) to sum the output currents for a respective column. Current digitizers 117 can determine the bitline currents 195 in the lines (e.g., bitlines) in the array 113 as multiples of a predetermined amount of current 232 to provide the summation results (e.g., 237, 236, . . . , 238) as the column outputs 197. Shifters 277 and adders 279 of the inference logic circuit 123 (or in the memory chip) can be used to combine the column outputs 197 with corresponding weights for different significant bits of weights (e.g., 250) as in FIG. 5 and with corresponding weights (e.g., 250) for the different significant bits of the inputs (e.g., 280) as in FIG. 6 to generate results of multiplication and accumulation.

The inference logic circuit 123 can provide the results of multiplication and accumulation as the output data 185. In response, the image compression logic circuit 122 can provide further input data 183 to obtain further output data 185 by combining the input data 183 with a weight matrix 181 in the memory cell array 113 through operations of multiplication and accumulation. Based on output data 185 generated by the inference logic circuit 123, the image compression logic circuit 122 converts the input image 162 into the output image 164.

For example, the input data 183 can be the pixel values of the input image 162 and an offset; and the weight matrix 181 can be applied to scale the pixel values and apply the offset.

For example, the input data 183 can be the pixel values of the input image 162; and the weight matrix 181 can be configured to compute transform coefficients of predetermined functions (e.g., cosine functions) having a sum representative of the pixel values, such as coefficients of discrete cosine transform of a spatial distribution of the pixel values. For example, the image compression logic circuit 122 can be configured to perform the computations of color space transformation, request the inference logic circuit 123 to compute the coefficients for discrete cosine transform (DCT), perform quantization of the DCT coefficients, and encode the results of quantization to generate the output image 164 (e.g., in a joint photographic experts group (JPEG or JPG) format).

For example, the input data 183 can be the pixel values of the input image 162; and the computation of an artificial neural network having the weight matrices 181 can be performed by the inference logic circuit 123 to identify one or more segments of the input image 162 containing content of interest. The image compression logic circuit 122 can adjust compression ratios for different segments of input image 162 to preserve more details in segments of interest and to compress more aggressively in other segments. Optionally, regions outside of the segments of interest can be deleted.

For example, an artificial neural network can be trained to rank the levels of interest in different segments of the input image 162. After the inference logic circuit 123 identifies the levels of interest in the output data 185 based on the computation of the artificial neural network responsive to the pixel values of the input image 162, the image compression logic circuit 122 can adjust compression ratios for different segments according to the ranked levels of interest of the segments. Optionally, the artificial neural network can be trained to predict the desired compression ratios of different segments of the input image 162.

In some implementations, a compression technique formulated using an artificial neural network is used. The output data 185 includes data representative of a compressed image; and the image compression logic circuit 122 can encode the output data 185 to provide the output image 164 according to a predetermined format.

FIG. 8 and FIG. 9 illustrate examples of an image processing logic circuit using an inference logic circuit in image compression according to one embodiment.

Similar to FIG. 7, the image processing logic circuit 121 in FIGS. 8 and 16 has an image compression logic circuit 122 configured to compress an input image 162 to generate an output image 164 using the computations performed by the inference logic circuit 123.

In FIG. 8, the image processing logic circuit 121 provides image data 161 representative of a column of pixel values as an input to the inference logic circuit 123 to obtain transform coefficients 187. The image processing logic circuit 121 can have an image compression logic circuit 122 configured to use the transform coefficients 187 to convert the input image 162 to the output image 164.

For example, the image compression logic circuit 122 can perform a color space transformation to convert the colors in the input image 162 from a source color space (e.g., intensity levels in red, green, blue) to a target color space more suitable for compression (e.g., intensity levels in luma or luminance, blue-difference chroma, and red-difference chroma).

After the color space transformation, the image compression logic circuit 122 provides a block of pixels based on pixel values in the target color space as the image data 161 to request the inference logic circuit 123 to convert the image data 161 into coefficients of functions such that the sum of the functions provides the pixel values at predetermines space locations. The inference logic circuit 123 can generate the coefficients 187 by multiplying a predetermined weight matrix 181 by a column of inputs representative of the pixel values received from the image compression logic circuit 122.

Similar to FIG. 7, the inference logic circuit 123 can use the voltage drivers 115 and current digitizers 117 to read the weight matrix 181 according to input bits 191 representative of the pixel values provided in the image data 161 to generate column outputs 197. When an input bit (e.g., 201) has a value of zero, a row of memory cells (e.g., 207, 206, . . . , 208) connected to a wordline driven by the voltage driver (e.g., 203) controlled by the input bit (e.g., 201) are not read; and thus the memory cells connected to the wordline output negligible amount of currents into bitlines (e.g., lines 241, 242, . . . , 243). When an input bit (e.g., 201) has a value of one, a row of memory cells (e.g., 207, 206, . . . , 208) connected to a wordline driven by the voltage driver (e.g., 203) controlled by the input bit (e.g., 201) are read; and thus each of the memory cells connected to the wordline outputs a predetermined amount of current 232 into bitlines (e.g., lines 241, 242, . . . , 243). The input bits 191 can have multiple bits that have values of one, which can cause multiple rows/wordlines to be read concurrently at the same time for summing as output currents in bitlines to obtain the column outputs 197 through the current digitizers 117. The shifters 277 and the adders 279 can combine column outputs 197 for different significant bits of inputs (e.g., 280) and weights (e.g., 250), as in FIG. 5 and FIG. 6, to generate, as the transform coefficients 187, the results of multiplication and accumulation operations.

Optionally, the image compression logic circuit 122 provides one block of image data 161 a time to the inference logic circuit 123 to obtain corresponding transform coefficients 187 (e.g., DCT coefficients) of the block. Alternatively, the image compression logic circuit 122 provides multiple block of image data 161 a time to the inference logic circuit 123; and the memory cell array 113 can store multiple copies of the weight matrix 181 to compute the coefficients 187 for the multiple blocks at the same time to speed up the computation.

After the conversion of a spatial distribution of pixel values for a block (e.g., 8×8 pixels), the image compression logic circuit 122 can perform quantization to discard some less visible components and encode the results of quantization to generate the output image 164.

In some implementations, the color space transformation can be performed via multiplying a color matrix by the column of color components. Such multiplication and accumulation operations can also be performed by the inference logic circuit 123. For example, the memory cell array 113 can include multiple copies of the color matrix; and a column of color components of multiple pixels can be used as an input for multiplication and accumulation with the color matrices to obtain the color components in the target color space.

In FIG. 9, the image processing logic circuit 121 provides image data 161 representative of a column of pixel values as an input to the inference logic circuit 123 to perform the computation of an artificial neural network trained to identify image segments 189 in the image data 161 that are of interest. For example, the segments 189 can be classified to contain images of objects of interest and in one or more predefined categories. In some implementations, the artificial neural network is trained to rank regions of the input image 162 to identify levels of interest in the regions. Segments having levels of interest above a threshold can be classified as segments of interest.

Based on the segments 189 identified as being of interest, or based on rankings of interest levels of different segments in the input image 162, the image compression logic circuit 122 can apply different compression strategies.

For example, the image compression logic circuit 122 can apply a first compression ratio to the segments 189 of interest in the input image 162 and apply a second compression ratio, higher than the first compression ratio to the remaining portion of the input image 162.

For example, the image compression logic circuit 122 can map the levels of interest for different segments of the input image 162 inversely to their compression ratios. A segment having a higher level of interest is compressed with a lower compression ratio than a segment having a lower level of interest. Thus, more details are preserved for segments of high levels of interest.

For example, the artificial neural network can be trained to predict the desirable compression ratios for different segments of the input image 162; and the image compression logic circuit 122 can be configured to compress different segments of the input images 162 according to the compression ratios predicted by the artificial neural network.

For example, the image compression logic circuit 122 can extract, from the input image 162, segments 189 of interest identified by the artificial neural network, compress the extracted segments 189, and discard the remaining portion of the input image 162.

In some implementations, the artificial neural network is trained to predict a compressed version of the input image 162.

The inference logic circuit 123 can perform the computation of the artificial neural network. The inference logic circuit 123 executes the instructions to apply the artificial neuron weight matrices 151 to provide the image segments 189, predicted levels of interest, a predicted compressed image, or any combination thereof, according to the outputs of output neurons in the artificial neural network.

Similar to FIG. 7, the inference logic circuit 123 can use the voltage drivers 115 and current digitizers 117 to read an artificial neuron weight matrix 151 according to input bits 191 representative of the image data 161 to generate column outputs 197. The shifters 277 and the adders 279 combine column outputs 197 for different significant bits of inputs and weights, as in FIG. 5 and FIG. 6, to generate the results of multiplication and accumulation operations. The inference logic circuit 123 can include a number of parallel logic circuits to preform activation functions 171 of artificial neurons. The inference logic circuit 123 can use the results of the activation functions 171 to determine the outputs of a set of artificial neuron and apply a next artificial neuron weight matrix 151 according to the computation instructions 155 to determine a column of combined inputs to a next set of artificial neurons. The process as controlled by the computation instructions 155 continues until the last set of artificial neurons provides, as the image segments 189, levels of interest, or predicted compressed image, or any combination thereof, the result of the artificial neural network responsive to the image data 161.

The computation of the image compression logic circuit 122 to compress the input image 162 and generate the output image 164 can include the determination of transform coefficients 187. Thus, the techniques of FIG. 8 and FIG. 9 can be used together. In general, the image processing logic circuit 121 can call or request the inference logic circuit 123 multiple times to perform various multiplication and accumulation operations in generating the compressed output image 164.

A device configured to be worn on a person (e.g., as a pair of augmented reality glasses 100) typically has space constraints that limit the configuration of energy, weight, and computing power in the device.

There are recent advances in passive neural networks that implement computations of artificial neural networks using meta neurons in the form of units or cells of photonic/phononic crystals and metamaterials. Such meta neurons can manipulate wave propagation properties in refraction, reflection, invisibility, rectification, scattering, etc. in ways corresponding to the computations of artificial neural networks.

For example, a passive neural network can be implemented via diffractive layers with local thicknesses configured according to the result of machine learning of an artificial neural network. For example, multiple layers of meta neurons can be used to interact with and scatter a wave rebounded from an object to passively perform the computations of a trained artificial neural network.

The energy in the received waves powers their further propagation through the meta neurons in a way corresponding to the computations of the artificial neural networks. Thus, no additional energy input is required for the passive neural networks to process the input waves in generating the outputs of the passive neural networks.

In at least some embodiments, a passive neural network is configured in an augmented reality device to process an image input to perform feature extraction and filtering with reduced or minimized energy consumption. When the input image with an object of interest is detected via the passive neural network, logic circuits in the augmented reality device can be powered up (e.g., via a battery pack) to further process the feature data generated by the passive neural network.

For example, an artificial neural network trained for an augmented reality device can have multiple layers of artificial neurons in processing an image, detecting an object in the image, and classifying or recognizing the object. A subset of initial layers of the artificial neural network can be implemented via a passive neural network and configured to generate a classification of whether to further process the image using the subsequent layers. The subsequent layers can be implemented via digital components and accelerated using a digital multiplication and accumulation accelerator. The functionality and the accuracy of the subsequent layers can be customizable for specific applications of interest to the user, and can be upgraded. Thus, the usability, feature, accuracy, and energy performance of the augmented reality device can be balanced via the split implementation of the artificial neural network using a hardwired passive neural network and a flexible, reprogrammable, digital implementation of artificial neurons.

Such an arrangement can alleviate the computational and energy burden on the battery powered digital components within the augmented reality device. Since the passive neural network does not drain the battery pack in performing the filtering and feature extraction, the energy performance of the augmented reality device is improved. The digital components configured in the augmented reality device can further perform computations of an artificial neural network, based on the outputs of the passive neural network. Thus, the functionality and accuracy of the augmented reality device can be improved beyond what can be hardwired into the passive neural network.

FIG. 10 shows a computing unit 102 having a passive neural network 305 and a digital multiplication and accumulation accelerator 319 configured according to one embodiment. For example, the computing unit 102 in the augmented reality glasses 100 of FIG. 1 can be implemented in a way as shown in FIG. 10.

In FIG. 10, an image generating device 303 (e.g., a lens) can be used to direct an image onto a passive neural network 305. The analysis of the image can be performed via an artificial neural network implemented via a combination of the passive neural network 305 and active components 331.

The passive neural network 305 has layers of meta neurons in the form of units or cells of photonic/phononic crystals and metamaterials manufactured with light wave manipulating properties corresponding to the attributes of a set of artificial neurons of the artificial neural network trained to detect and recognize objects in the images from the image generating device 303.

The active components 331 of the computing unit 102 can include a processor 311 configured to execute instructions, a memory 315 configured to store the instructions and data to be used by the instructions, and a digital multiplication and accumulation accelerator 319. An interconnect 317 connects the processor 311, the memory 315, the digital multiplication and accumulation accelerator 319, and an image sensor 313 configured to convert the processing results of the passive neural network 305 from an analog form of light patterns, to a digital form of data to be further processed by the processor 311.

For example, the artificial neural network can be trained to analyze an image of a scene and identify or recognize an object in the scene. The artificial neural network can include a first portion configured to filter and extract features in the image and thus reduce the size of data to be further analyzed in a second portion of the artificial neural network.

The feature extraction portion of the artificial neural network can be implemented via the passive neural network 305; and the object identification/classification portion of the artificial neural network can be implemented via software executed in the processor 311 using weight matrices of the artificial neurons stored in the memory 315. The processor 311 can use the accelerator 319 to accelerate the computations of multiplication and accumulation involving the weight matrices.

Optionally, the computing unit 102 is configured in an integrated circuit device. An integrated circuit package 333 is configured to enclose the meta neurons of the passive neural network 305 and the active components 331. Alternatively, one or more of the active components 331 (e.g., the processor 311, the memory 315, or the accelerator 319, or a combination thereof) can be configured in one or more separate integrated circuit devices outside of the integrated circuit package 333 enclosing the passive neural network 305 and the image sensor 313.

The active components 331 can be powered by a battery pack 320 and connected to a communication device 157 and a display device 309. The battery pack 320 can also power the display device 309 and the communication device 157.

For example, the communication device 157 can be used for a wireless connection 104 to a nearby computing device 106, or a remote server computer system 110, or both, for augmented reality based on the images processed by the passive neural network 305.

For example, information about an object recognized from an image processed by the passive neural network 305 can be presented on the display device 309 that is configured on a pair of augmented reality glasses 100. Thus, the reality as seen through the glasses 100 can be augmented by the information about the object presented via the display device 309.

In some implementations, a light of a monochromatic plane wave is used to illuminate a scene. The light as reflected by objects in the scene can be directed by the image generating device 303 to form an image of light pattern incident on an outermost layer of meta neurons of the passive neural network 305. The light of the image can propagate through the meta neurons of the passive neural network 305 to generate a light pattern as an output of the passive neural network 305. The image sensor 313 can convert the light pattern into digital data for further processing by the active components 331.

The image generating device 303 can include a light filter to prevent lights from other sources from entering the passive neural network 305.

In other implementations, an image sensor is used to capture an image of a scene without requiring the use of a controlled light source to illuminate the scene. Based on the captured image, the image generating device 303 can generate an image with wave properties suitable for processing by the passive neural network 305, and direct the generated image on the outermost layer of meta neurons of the passive neural network 305. The light in the generated image can propagate through the passive neural network 305 to generate an output light pattern. The image sensor 313 measures the output light pattern to generate data for further processing by the processor 311 according to artificial neurons.

The use of the passive neural network 305 to implement a portion of the computations of an artificial neural network of the augmented reality application can reduce the energy consumption by the computing unit 102 and improve the energy performance supported by the battery pack 320.

Further, in some implementations, the output of the passive neural network 305 can be used to control the activities of the active components 331 during the monitoring of a scene to detect an object of interest, as in FIG. 11.

FIG. 11 illustrates the processing of an image using a passive neural network configured according to one embodiment. For example, the technique of FIG. 11 can be implemented in the computing unit 102 of FIG. 10 and FIG. 1 of augmented reality glasses 100.

In FIG. 11, image light 341 (e.g., from an image generating device 303) incident on an outermost layer of meta neurons of a passive neural network 305 can propagate through the passive neural network 305 to generate a light pattern 342 without draining the power of a power supply (e.g., battery pack 320).

The passive neural network 305 is configured according to layers of artificial neurons to extract features from the image formed by the light 341. The light pattern 342 is representative of data identifying the features extracted by the passive neural network 305.

An array of light sensing pixels 343 (e.g., configured in an image sensor 313) can convert the light pattern 342 to neuron outputs 345 that are the data representative of the features extracted by the passive neural network 305 from the image light 341. Each pixel in the light sensing pixels 343 can be positioned to measure the light in a respective area in the pattern 342. One of the areas in the light pattern 342 is configured to output an interest level indicator 371 generated via an output meta neuron; and a corresponding pixel 361 is configured to measure the light in the area to provide a neuron output configured as an interest level indicator 371. Other areas of the light pattern 342 provide image feature data 373 configured to be measured via image feature pixels 363 in the light sensing pixels 343.

The output of the interest level pixel 361, generated by the passive neural network 305 responsive to the image light 341, can be used as an interest level indicator 371 to control the power manager 347 in powering the operations of image feature pixels 363, or the processor 311, or both.

For example, when the interest level indicator 371 is below a threshold, the power manager 347 can operate the processor 311 and the image features 363 in a low power mode (e.g., a power off mode, a sleep mode, a hibernation mode). Thus, before the interest level indicator 371 reaches the threshold, the system can use the passive neural network 305 to monitor the image light 341 with reduced or minimized energy expenditure. When an object of interest enters the scene having the image light 341, the interest level indicator 371 can be above the threshold, causing the power manager 347 to power up the processor 311 and the operations of image feature pixels 363 for further analysis of the neuron outputs 345 using further artificial neurons implemented via weight matrices 349 and instructions 351 stored in the memory 315.

Optionally, a digital multiplication and accumulation accelerator 319 can be used to accelerate the computations of multiplication and accumulation involving the weight matrices 349. The digital multiplication and accumulation accelerator 319 can have processing units configured to execute instructions having matrix operands, and vector operands.

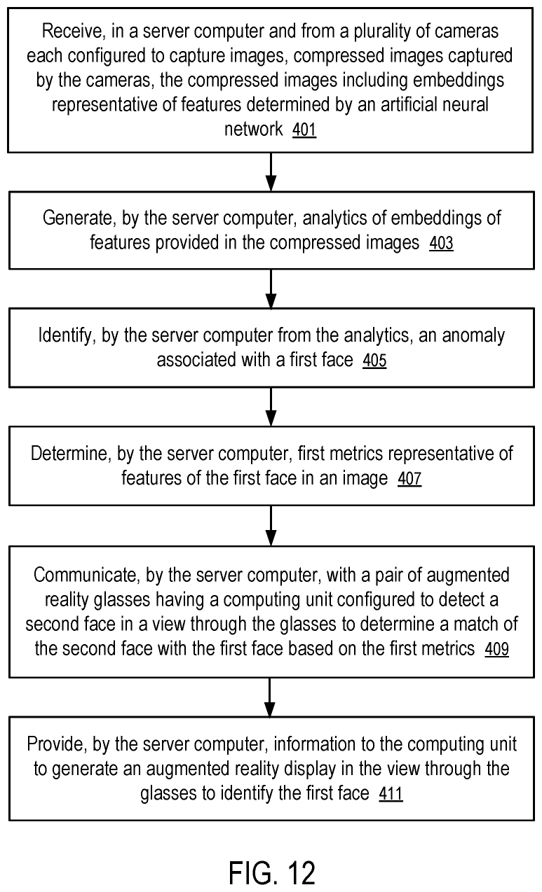

FIG. 12 shows a method of augmented reality according to one embodiment. For example, the method of FIG. 12 can be implemented in a security system of FIG. 1.

For example, the security system can include a plurality of cameras 118. Each of the cameras 118 can have a computing unit 126 to compress its capture images via an artificial neural network, and provide compressed video data 116 having embeddings representative of features determined by the artificial neural network for object detection, recognition and behavior analysis.

Further, the security system can include a server computer system 110 configured to receive, from the cameras 118, compressed video data 116 to generate analytics 114 of embeddings of features in the compressed video data 116. The server computer system 110 can identify, from the analytics 114, an anomaly associated with a first face, and determine first metrics 112 representative of features of the first face in an image (e.g., in compressed video data 116).

The security system can include at least one pair of augmented reality glasses 100 having a computing unit 102 configured to detect a second face 124 in a view through the glasses 100, communicate with the server computer system 110 to determine a match of the second face 124 with the first face based on the first metrics 112, and generate an augmented reality display in the view through the glasses 100 to identify the first face 124 to a user of the glasses 100.

At block 401, a server computer (e.g., system 110) receives, from a plurality of cameras 118 (each configured to capture images), compressed images (e.g., data 116) captured by the cameras 118. The compressed images include embeddings representative of features determined by an artificial neural network. The features can be used in object detection, recognition, and behavior analysis using an artificial neural network.

At block 403, the server computer generates analytics 114 of embeddings of features provided in the compressed images.

For example, the server computer system 110 can perform statistical analyses to identify persons or faces having attributes that are outliers.

For example, the server computer system 110 can use an artificial neural network to perform a facial expression analysis of an image in the compressed video data 116 on a face on a person in a crowd monitored by the cameras. The recognized expressions in the crowd can be compared to identify outliers having unexpected expressions that may cause concerns.

For example, the server computer system 110 can use an artificial neural network to perform a behavior change analysis (e.g., of walking pattern) to recognize a pattern associated with an indication of intoxication, sickness, or injury of a person having a face captured in the compressed video data 116.

At block 405, the server computer identifies, from the analytics 114, an anomaly associated with a first face (e.g., captured in the compressed video data 116).

At block 407, the server computer determines first metrics 112 representative of features of the first face in an image (e.g., in the data 116).

At block 409, the server computer communicate with a pair of augmented reality glasses 100 having a computing unit 102 configured to detect a second face 124 in a view through the glasses 100 to determine a match of the second face 124 with the first face (e.g., in the compressed video data 116) based on the first metrics 112 associated with the anomaly.

For example, in response to the detection of the anomaly, the server computer system 110 can transmit the first metrics 112 to the computing units (e.g., 102) of augmented reality glasses (e.g., 100) worn by authorized users, causing the augmented reality glasses (e.g., 100) to look out of matching faces (e.g., 124). When the computing unit 102 of a pair of augmented reality glasses 100 recognizes the second face 124 as being corresponding to the first face based on the first metrics 112, the augmented reality glasses 100 can call out the second face 124 for the user wearing the glasses 100 for attention.

Alternatively, when the computing unit 102 detects the second face 124 in the view, the computing unit 102 can send second metrics of the second face 124 to the server computer system 110 to check whether the second face 124 is of interest and/or has an associated anomaly. If the server computer system 110 determine that the second face 124 corresponds to the first face based on matching the first metrics derived from the compressed video data 116 captured by a camera 118 and the second metrics derived from an image captured by the glasses 100, the server computer system 110 can instruct the computing unit 102 to identify the second face 124 in the view through the glasses 100 via augmented reality display.

At block 411, the server computer provides information to the computing unit 102 to generate an augmented reality display in the view through the glasses 100 to identify the first face 124 to the user of the glasses 100.

For example, the augmented reality display can include a highlight of the face in the view through the glasses 100. Alternatively, or in combination, the augmented reality display can include a symbol representative of a classification of the anomaly; and the symbol is presented next to the second face 124 in the view through the glasses 100. Optionally, the highlight of the face can be in a style that identifies the classification of the anomaly.

Optionally, the server computer system 110 can determine an identity of a person having the first face captured in the compressed video data 116, retrieve a record of the person, and transmit the record in text to the computing unit 102 of the glasses 100. The computing unit 102 can present the record via audio in connection with the augmented reality display.

Optionally, the augmented reality glasses 100 can be configured to receive a user request. In response, the server computer system 110 can provide a representative image (e.g., extracted from the compressed video data 116) of the anomaly to the computing unit 102 for presentation via the glasses 100. The user of the glasses 100 can review the representative image and determine whether the classification of anomaly can be dismissed. If so, the augmented reality glasses 100 can receive an input representative of the dismissal request; and in response, the server computer system 110 can cancel requests to look out and monitor the person having the first face identified by the first metrics 112 previously associated with an anomaly.

The computing unit 102 of the augmented reality glasses 100 can be configured with an artificial neural network to recognize the second face 124 in the view through the glasses 100. Optionally, a first portion of the artificial neural network is implemented via a passive neural network 305; and a second portion of the artificial neural network is implemented via a processor 311, a memory 315 storing weight matrices 349 of the second portion and instructions to perform the computations of the second portion, and an accelerator (e.g., 319) of multiplication and accumulation operations.

Optionally, the accelerator (e.g., 319) is implemented via parallel logic circuits to accelerate multiplication and accumulation operations. Alternatively, a memory cell array 113 can be used to both store the weight matrices 349 and perform multiplication and accumulation operations as illustrated in FIG. 4, FIG. 5, and FIG. 6.

The memory 315 can be a memory sub-system having media, such as one or more volatile memory devices (e.g., memory device), one or more non-volatile memory devices (e.g., memory device), or a combination of such. The memory sub-system can be coupled to a host system (e.g., having a processor 311) in a computing system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

A memory sub-system can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The host system can include a processor chipset (e.g., processing device) and a software stack executed by the processor chipset. The processor chipset can include one or more cores, one or more caches, a memory controller (e.g., controller) (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, and/or a combination of communication connections.

The processing device of the host system can be, for example, a microprocessor, a central processing unit (CPU), a processing core of a processor, an execution unit, etc. In some instances, the controller can be referred to as a memory controller, a memory management unit, and/or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller and/or the processing device can include hardware such as one or more integrated circuits (ICs) and/or discrete components, a buffer memory, a cache memory, or a combination thereof. The controller and/or the processing device can be a microcontroller, special purpose logic circuitry (e.g., a field programmable gate array (FPGA), an application specific integrated circuit (ASIC), etc.), or another suitable processor.

The memory devices can include any combination of the different types of non-volatile memory components and/or volatile memory components. The volatile memory devices (e.g., memory device) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs) and/or discrete components, a buffer memory, or a combination thereof. The hardware can include digital circuitry with dedicated (i.e., hard-coded) logic to perform the operations described herein. The controller can be a microcontroller, special purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While an example memory sub-system has been illustrated as including the controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local controller (e.g., local controller) for media management within the same memory device package. An example of a managed memory device is a managed NAND (MNAND) device.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a plurality of cameras, each of the cameras configured to capture images, compress the images via an artificial neural network, and provide first compressed images having embeddings representative of features determined by the artificial neural network;
a server computer configured to receive, from the plurality of cameras, second compressed images to generate analytics of embeddings of features in the second compressed images, identify from the analytics an anomaly associated with a first face, and determine first metrics representative of features of the first face in an image; and
at least one pair of augmented reality glasses having a computing unit configured to communicate with the server computer to determine a match of a second face in a view through the glasses with the first face based on the first metrics, and generate an augmented reality display in the view to identify the first face.

2. The system of claim 1, wherein the server computer is configured to detect the anomaly via a facial expression analysis based on the first face having an expression that is an outlier in expressions on faces on a crowd of people monitored by the cameras.

3. The system of claim 1, wherein the server computer is configured to detect the anomaly via a behavior change analysis to recognize a pattern associated with an indication of intoxication, sickness, or injury of a person having the first face.

4. The system of claim 1, wherein the server computer is configured to transmit the first metrics to the computing unit; and the computing unit is configured to recognize the second face as being corresponding to the first face based on the first metrics.

5. The system of claim 1, wherein the computing unit is configured to transmit second metrics of the second face to the server computer; and the server computer is configured to determine that the second face corresponds to the first face based on matching the first metrics and the second metrics.

6. The system of claim 1, wherein the augmented reality display includes a highlight of the face in the view through the glasses.

7. The system of claim 6, wherein the augmented reality display further includes a symbol representative of a classification of the anomaly and the symbol is presented next to the second face in the view through the glasses.

8. The system of claim 7, wherein the server computer configured to determine an identity of a person having the first face, determine a record of the person, and transmit the record to the computing unit; and the computing unit is configured present the record via audio in connection with the augmented reality display.

9. The system of claim 8, wherein the server computer is further configured to provide a representative image of the anomaly to the computing unit for presentation via the glasses in response to a request from a user of the augmented reality glasses.

10. A method, comprising:
receiving, in a server computer and from a plurality of cameras each configured to capture images, compressed images captured by the cameras, the compressed images including embeddings representative of features determined by an artificial neural network;
generating, by the server computer, analytics of embeddings of features provided in the compressed images;
identifying, by the server computer from the analytics, an anomaly associated with a first face;
determining, by the server computer, first metrics representative of features of the first face in an image; and
communicating, by the server computer, with a pair of augmented reality glasses having a computing unit configured to detect a second face in a view through the glasses to determine a match of the second face with the first face based on the first metrics; and
providing, by the server computer, information to the computing unit to generate an augmented reality display in the view through the glasses to identify the first face.

11. The method of claim 10, wherein the augmented reality display includes:
a highlight of the face in the view through the glasses; and
a symbol, representative of a classification of the anomaly, presented next to the second face in the view through the glasses.

12. The method of claim 11, further comprising:
determining, by the server computer, an identity of a person having the first face;
retrieving, by the server computer, a record of the person; and
transmit, by the server computer, the record to the computing unit to cause the computing unit to present the record via audio in connection with the augmented reality display.

13. The method of claim 12, further comprising:
transmitting, by the server computer, a representative image of the anomaly to the computing unit to cause the computing unit to present the representative image via the glasses in response to a request from a user of the augmented reality glasses.

14. The method of claim 13, further comprising:
performing, by the server computer, a facial expression analysis of the compressed images; and
detecting, by the server computer, the anomaly in response to a determination that the first face has an expression that is an outlier in expressions on faces on a crowd of people monitored by the cameras.

15. The method of claim 13, further comprising:
performing, by the server computer, a behavior change analysis to recognize a pattern associated with an indication of intoxication, sickness, or injury of a person having the first face.

16. The method of claim 13, further comprising:
transmitting, by the server computer in response to detection of the anomaly, the metrics to the computing unit to cause the computing unit to recognize the second face as being corresponding to the first face based on the first metrics; and
dismissing, by the server computer, an anomaly classification of the representative image associated with the first face in response to an input from a user of the augmented reality glasses.

17. The method of claim 13, further comprising:
receiving, by the server computer from the computing unit, second metrics of the second face;
making, by the server computer in response to receiving the second metrics, a determination that the second face corresponds to the first face; and
providing, by the server computer in response to the determination, information about the anomaly to cause the computing unit to generate the augmented reality display.

18. An apparatus, comprising:
a pair of glasses; and
a computing unit configured to receive, from a server computer, first metrics of a first object image, detect a second object image in a view through the glasses, recognize the second object image as being corresponding to the first object image based on the first metrics, and generate an augmented reality display in the view to identify the first object image.

19. The apparatus of claim 18, wherein the first object image and the second object image are representative of a face of a person; and the augmented reality display includes:
a highlight of the face in the view through the glasses; and
a symbol, representative of a classification of the anomaly, presented next to the second face in the view through the glasses.

20. The apparatus of claim 19, wherein the computing unit is configured via an artificial neural network to recognize the face; a first portion of the artificial neural network is implemented via a passive neural network; and a second portion of the artificial neural network is implemented via a processor and an accelerator of multiplication and accumulation operations.
